(19) United States
(12) Patent Application Publication
(10) Pub. No.: US 2013/0207748 A1
(43) Pub. Date: Aug. 15, 2013

(54) POWER DUAL-BAND ROTARY JOINT OPERATING ON TWO DIFFERENT BANDS

(71) Applicants: Antonio Morini, Ancona (IT); Vincenzo Malaspina, Monte Gilberto (IT); Paolo Panichi, Grottammare (IT)

(72) Inventors: Antonio Morini, Ancona (IT); Vincenzo Malaspina, Monte Gilberto (IT); Paolo Panichi, Grottammare (IT)

(73) Assignee: G.E.M. Electronica S.r.l, San Bendetto del Tronto (IT)

(21) Appl. No.: 13/814,082

(22) PCT Filed: Jul. 28, 2011
(86) PCT No.: PCT/EP2011/003800

§ 371 Date: May 3, 2013

(30) Foreign Application Priority Data
Aug. 3, 2010 (IT) AP2010A000011

(51) Int. Cl. H01P 1/06

(52) U.S. Cl. CPC H01P 1/062
USPC 333/256

(57) ABSTRACT

A power dual-band rotary joint simultaneously operating on two frequency bands. A and is made up of a couple of transducers, each between two rectangular waveguides, respectively operating, on bands A and B, and a nested coaxial waveguide. The nested coaxial waveguide is made up of two concentric cylindric waveguides. The transducers are conceived in such a way that only modes with azimuthal symmetry are excited. The nested coaxial waveguide dimensions are chosen so that, on band B, the TM01 mode can propagate in the circular waveguide delimited by the internal surface of the smaller cylinder. The external surface of the smaller cylinder is the internal conductor of the coaxial working on band A, while the internal surface of the bigger cylinder is the external conductor of the same coaxial. The two transducers are connected through the nested waveguide.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates in general to radar systems, and more particularly pertains to the field of dual-band radars, which can operate on two different frequency carriers, which in turn correspond to different waveguides as well, for instance, on the X band (8-12.4 GHz, WR90 waveguides) and on Ka (26-40 GHz, WR28 waveguides). The first lower frequency is used for the detection of Ion g distance obstacles. The higher frequency is used for the focalization of the obstacle, when it is approaching. For such systems, the rotary joint is an essential component, as it connects the transmitters to the antennas which are on a rotating support, in such a way that it can perform an azimuth scanning of the surrounding space.

The rotary joint must connect two couples of rectangular waveguides of different cross-sections and, correspondingly, working frequency, in a way that each couple can rotate with respect to the other, without affecting the return loss on each band (higher than 20 dB, on both bands), guaranteeing high isolation between waveguides operating at different frequencies (Isolation higher than 60 dB), small insertion loss (lower than 1 dB on both bands), immunity of the performance with respect to rotation angle (WOW smaller than 0.5 dB) and, finally high peak power capability (in excess of 72 dBm).

2. Description of Related Art Including Information Disclosed Under 37 CFR 1.97 and 37 CFR 1.98.

There are a lot of single-band rotary joints available on the market:

All these devices are formed by a couple of junctions (otherwise called transducers) between a cylindrical and a rectangular waveguide connected through a bearing mechanism in such a way that a junction can rotate with respect to the other. The two parts are called stator and rotor, respectively. The junction is conceived in such a way that only the lower order mode with a azimutal symmetry is excited in the cylindrical waveguide, and the transmission does not depend on the reciprocal angle between the two junctions.

This is also the simplest case, as the coaxial waveguide works in mononiodal region. On the other hand, a millimeter frequency, coaxial waveguide presents high losses and expensive manufacturing costs. In addition, when specifications on power handling capability are more stringent, solutions other than coaxial waveguides must be chosen [1]. A great improvement is achieved by using a circular waveguide as the rotating part. In that case, however, the waveguide must operate under symmetrical modes, exploiting for example TM01 or TE01, which are the lowest order ones. Such a requirement is needed to obtain a structure that is symmetrical not only mechanically but also electrically. The issue is, of course, to prevent the fundamental modes TE11. (with vertical and horizontal polarization, V and H) from being excited, since that would make transmission sensitive to rotation angle. [1] D. G. de Mesquita, A. G. Bailey, “A Symmetrically Excited Microwave Rotary joint.” IEEE Trans. Microwave Theory and Tech., vol. 18. No. 09, pages 654-656, September 1970;

For this reason, on the basis of symmetry, many transducers were invented, aimed at exciting only one mode (TM01 [2]-[5] or TE01 [6]), though not the fundamental one, or, alternatively the TE11 mode, circularly polarized: [2] Smimov. A. V., Yu, D. U. L., “Symmetrized coupler converting circular waveguide TM01 mode to rectangular waveguide TE10 mode”, US Patent No 20080068110, 2008;[3] Tavassoli Maui, Behzad, “Mode transducer structure”, U.S. Pat. No. 7,446,623, 2008;[4] Fisher W. Clifford, “Radar rotary joint”, U.S. Pat. No. 4,654,613, 1987;[5] Ching-Fang Yu and Tsun -Hsu Chang, “High-Performance Circular TEO1-Mode Converter”, IEEE Trans. Microwave Theory and Tech., vol. 53, No. 12, pages 3794-3798, December 2005;[6] Y. Aramaki, N. Yoneda, M. Miyazaki, Moriyasu, A. lida, I, Naito, T. Horie, Y. Yutaka, “Rotary joint”, U.S. Pat. No. 7,091,804, 2006.
[7] O. M. Woodward, “A Dual-Channel Rotary Joint For High Average Power Operation”, IEEE Trans. Microwave Theory and Tech., Vol. 18, no. 12, pages 1072-1077. December 1970; in such a way that the conversion is independent of the angle.

In order to achieve this goal, there are the following alternatives:
1) Coaxial waveguide, operating on the fundamental TEM mode;
2) Circular waveguide, operating on the TM01 mode, which is the lowest order mode having azimutal symmetry. Unfortunately, the TM01 mode is not the fundamental one, because both TE11V and TE11H mode have a lower cut-off frequency:
3) Circular waveguide operating on the TE11 mode with circular polarization (RHCP or LMCP). This solution requires a couple of polarizers, which make the device more involved. Typically, when the rotary joint operates in a single band, the first option is preferred. On the other hand, when dual-band operating mode is required, and the working frequencies belong to different waveguide hands (I/O), the usage of a common coaxial waveguide suffers from several drawbacks, mostly due to the need of reducing the coaxial section in such a way that it is monomodal on the upper band thus increasing losses and lowering the “power handling capability”. In addition, the realization of the choke providing electrical continuity at the level of the break, necessary to make the rotation possible, is difficult because it must work on both bands.

An alternative solution is the use of a circular waveguide, oversized in such a way that at least two modes with azimuthal symmetry can propagate (circularly polarized TE11 and TM01
[8] S. Ghosh, L. C. Da Silva, “Waveguide rotary joint and mode transducer structure therefor”, U.S. Pat. No. 5,442,329, 1995 for “Antenna Feed Systems”, Artech House, Norwood, Mass., 1993: and TM01 and TEO1 in:
[9] D. A. MacNamara and L. T. Hildebrand. “Fullwave analysis of non-contacting rotary joint choke section using the generalized scattering matrix (GSM) approach”, IEE Proc.—Microwave, antennas Propagation, vol. 150 No. 1, February 2003, pages 5-10.

The two modes are separated, being mutually orthogonal, thus providing connection for the two bands. Even in this case, one of the main issues concerns the choke, which has to work at frequency 1 for mode 1 and at frequency 2 for mode 2.

The two TE11 V and H circular waveguide lower order modes are prevented by a suitable choice of the symmetry of the transducers.

It must be noted that in both cases, the azimuthal symmetry waveguide cannot be mechanically continuous: a break is necessary to make possible the rotation of the rotor with respect to the stator. On the other hand, the cut must be designed in a way that it does not permit field leakage. As a matter of fact, this circumstance would increase the insertion loss. The electrical continuity is restored by the insertion, at the level of the cut, of a suitable microwave device called a ‘choke’, formed. by a combination of coaxial and λ/4 radial lines. The impedance transformation is designed in such a way that even though there is a cut there is in fact a electromagnetic continuity.

The closest prior art to the present invention is considered:
[10] the U.S. Pat. No. 3,026,513 A (Kurtz Louis) which discloses a rotary joint, comprising first and second transducers, each transducer connecting two rectangular waveguides to a nested coaxial waveguide. The transducers are connected through the nested waveguides.

The subject matter claimed by the present invention differs from this known rotary joint in that the waveguides operate on different frequency bands.

U.S. Pat. No. 3,026,513 does also not mention the chokes integrated in the nested waveguides and the other technical details present in claim 1 with regard to the nested coaxial waveguide, which improve the electrical properties of the dual-band rotary joint.

### BRIEF SUMMARY OF THE INVENTION

The power dual-band rotary joint of the present invention simultaneously operates on two frequency bands, A and B, made up of several transducers, each between two rectangular waveguides, respectively operating on bands A and B, and a nested coaxial waveguide. The nested coaxial waveguide is made up of two concentric cylindric waveguides. The transducers are conceived in such a way that only modes with azimuthal symmetry are excited. The nested coaxial waveguide dimensions are chosen so that, on band B, the TM01 mode can propagate in the circular waveguide delimited by the internal surface of the smaller cylinder. The external surface of the smaller cylinder is the internal conductor of the coaxial working on band A, while the internal surface of the bigger cylinder is the external conductor of the same coaxial. The two transducers are connected through the nested waveguide. This connection system also contains a mechanism making possible that each transducer can rotate with respect to the other, as well as two chokes necessary to restore the electromagnetic continuity cut-off by the breaks. As the symmetry of the modal transducers makes possible the excitation of the only TM01 modes on band B and TEM modes on band A and that other modes, though above cutoff, are not excited at all, it allows that the electromagnetic behaviour is quite independent from the rotation angle of the rotary joint.

### BRIEF DESCRIPTION OF THE SEVERAL VIEWS OF THE DRAWINGS

FIG. 1 is a global sectional view of the A-band rectangular waveguide port input, the A-band rectangular waveguide port output, the B-band rectangular waveguide port input, the B-band rectangular waveguide port input, the circular waveguide for B-band, the coaxial waveguide for A-hand, the A-band choke break, the A-band choke, the B-band choke break and the B-band choke.

FIG. 2 is a transparent sectional view of the first transducer.

FIG. 3 is a transparent sectional view of the second transducer.

FIG. 4 is a vertical section of the rotary joint.

FIG. 5 is an axial view of B-band rectangular to circular transition.

FIG. 6 is an axial view of A-band rectangular to coaxial transition

### DETAILED DESCRIPTION OF THE INVENTION

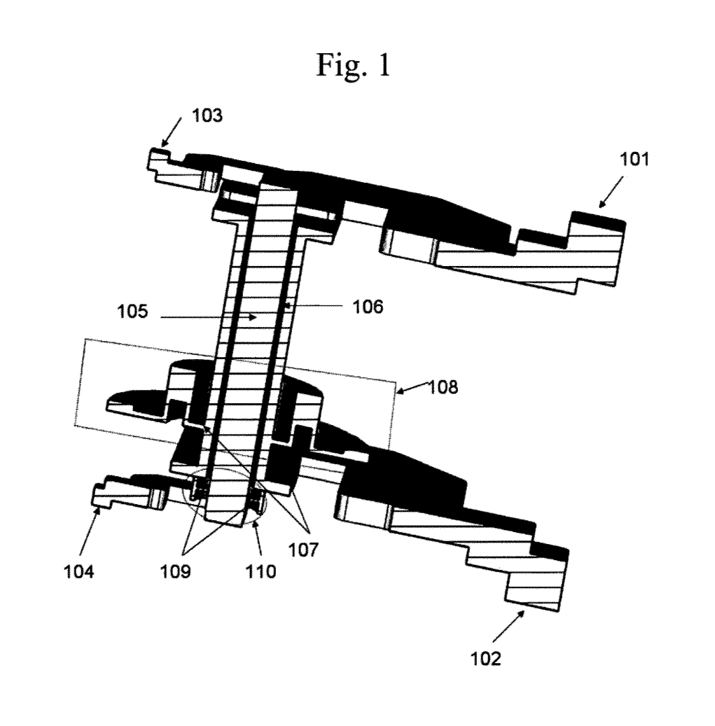

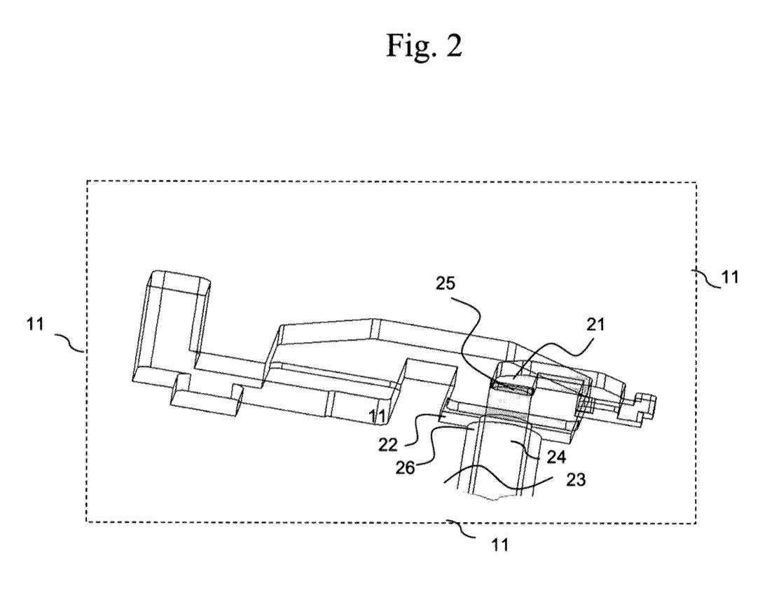

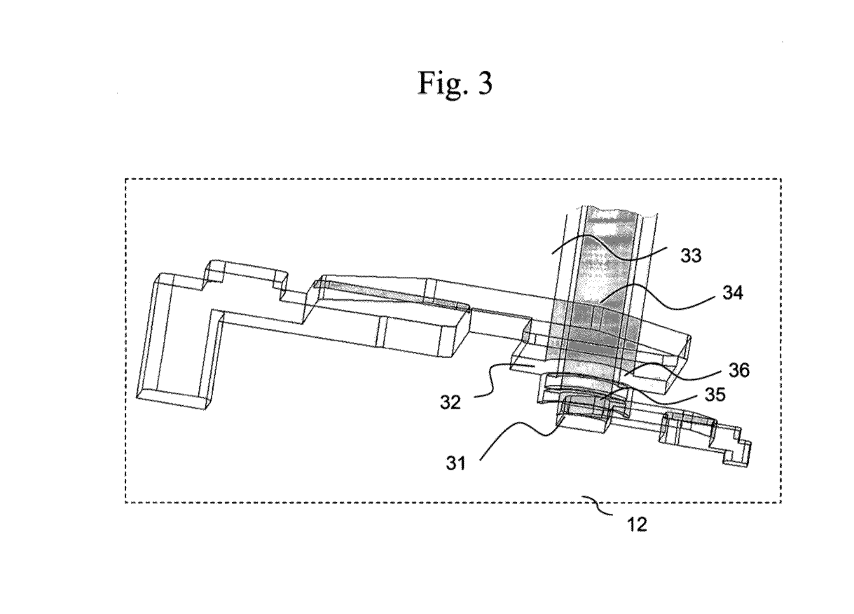

The present invention would like to overcome the issues discussed above, by using a dual band rotary joint, operating on the bands A and B (X and Ka, in a preferred embodiment) made up of two transducers T1 (11) and T2 (12). each connecting two rectangular waveguides to a cylindrical waveguide supporting modes with azimuthal symmetry. The internal part of the whole rotary joint, including the two transducers (rectangular waveguide-nested waveguide) and two chokes for the bands A and B, is shown in the FIG. 1 (For the sake of clarity, the figure shows just one half of the symmetric rotary joint). In the figure said transducers T1 and T2 are labelled by FIGS. 2 and 3, respectively (for the sake of clarity, the figure shows just half transducers because they are symmetric as well).

The rectangular waveguide ports are labelled by the numbers (101) and (102), for band A, (103) and (104), for band B.

The cylindrical part is indeed a double coaxial waveguide, made up of two concentric cylindrical waveguides, also called ‘coaxial nested waveguide’. The internal surface of the first cylindrical shell defines a circular waveguide, where the mode TM01 can propagate, on band B (105). The external surface of the first cylindrical shell is the internal conductor of the coaxial working on band A (106), whose external conductor is given by the internal pan of the second cylindrical conductor. This kind of nested waveguide has been mainly used in some double-band antenna feeds:
[11] S. L. Johns, A. Patra Jr, “An Ultra Wideband Nested Coaxial Waveguide Feed for Reflector Antenna Applications”, IEEE Antennas and Propagation Society Int. Symposium, pages 704-707, 1999;
[12] M. L. Livingston, “Multifrequency Coaxial Cavity Apex Feeds”, Microwave J. Vol. 22, October 1979, pages 51-54;
[13] J. C. Lee, ‘Compact Broadband. Rectangular to Coaxial Waveguide Junction’, U.S. Pat. No. 4,558,290, 1985;

Very recently, it been used in the rotary joint developed for the antenna designed for the Bepi-Colombo mission:
[14] J. A. Murer, R. Harper, “High Temperature Antenna Pointing Mechanism for BepiColombo Mission”, 11th European Space Mechanisms and Tribology Symposium, ESMATS 2005, 185-194;
   from which, the present patent differs just for the modal transducer designed for coupling the two rectangular waveguides to the ‘nested coaxial’ waveguide.

In addition, there are two chokes restoring the electromagnetic continuity at the two cut planes of the ‘nested coaxial’, necessary to make rotation possible.

In fact there are two breaks. The first (107) cuts only the external cylinder of the nested waveguide, thus producing a discontinuity only for the TEM mode propagating within the coaxial waveguide formed by the external surface of the internal cylinder and the internal surface of the external cylinder, while the electromagnetic wave propagating within the inner of the internal cylinder (105) is not affected at all. The electrical continuity takes place through the choke A (108), which, for the above reasons, has to work just on band A. The bearing mechanism permitting rotation is also installed at the level of this break. There is then a second break (109) of the internal cylinder of the ‘nested ’ waveguide placed below the transducer working on band A (at the bottom of the figure).

Even in this case, the electromagnetic continuity is restored on band B, through the insertion of the choke B (110), designed in such a way that no leakage occurs between the waveguides operating on band B toward the waveguides operating on band A. The transducer between circular and rectangular waveguides on band B is seen by the waveguides operating on band A as a reactive load.

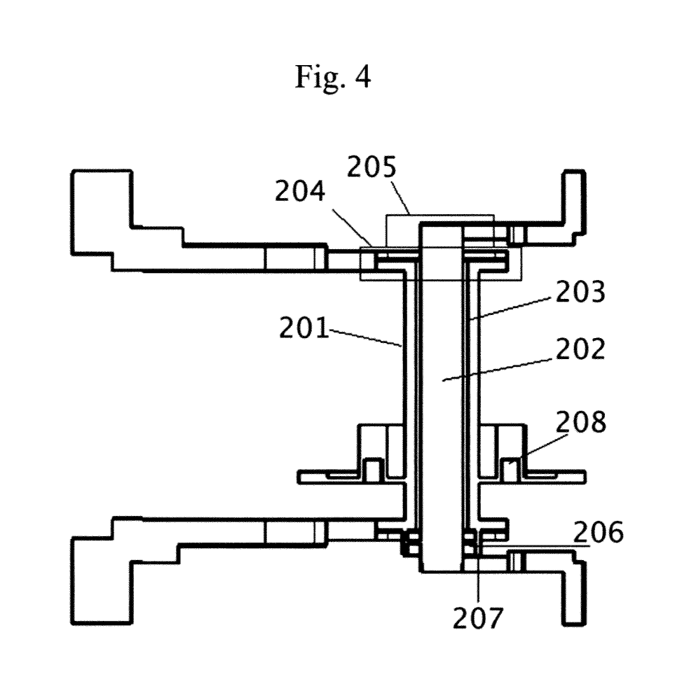

In order to make more clear the working principles, FIG. 4 shows one section of the internal part. The main parts are:
(201) External coaxial waveguide, CXA.
(202) Internal circular waveguide WCB.
(203) Wall, whose internal surface delimits the internal circular waveguide, while the external surface delimits the internal conductor of the coaxial.
(204) Transition WRA1-CXA1 between rectangular and coaxial waveguides working on band A.
(205) Transition WRB1-WCB1 between rectangular and circular waveguide B.
(206) Gap between the two circular waveguides WC1 and WC2.
(207) Choke for the circular waveguide WCB.
(208) Gap between the coaxial waveguides CX1 and CX2, including the choke,

More in detail, with reference to the two bands X and Ka, the transducer is formed by two distinct transitions: the transition operating on Ka band, uses a circular waveguide fed in such a way that only the TM01 mode is excited. Such a transition is similar to the one proposed in [1] D. G. de Mesquita, A. G. Bailey, “A Symmetrically Excited Microwave Rotary Joint” IEEE Trans. Microwave Theory and Tech., vol. 18, No. 09. pages 654-656, September 1970.

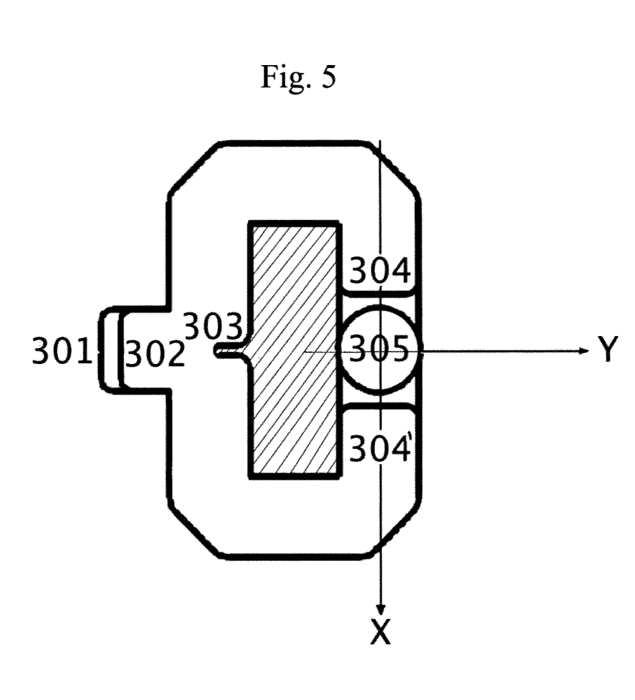

Half of the transition rectangular waveguide (WR28)—circular waveguide (WC) (H-plane section) is shown in FIG. 5. The symmetry of the transition is chosen in such a way that in the planes y=0 and x=0 there are two magnetic walls, which prevent the excitation of the lower order modes TE11, H and V. The signal entering the port (301) is split into two identical parts through the bifurcation in the H. The step (302) and the septum (303) are used for matching. There is a further matching step (304) used to compensate the mismatching due to the transition rectangular—circular waveguide (305). Radius of the Ka-band circular waveguide is chosen in such a way that TM01 is above cut-off.

The transition on X band between rectangular-coaxial waveguide employs a coaxial waveguide, whose internal conductor is just the external surface of the circular waveguide (of radius Ri) used on Ka band. The diameter of the internal conductor is therefore 2Ri+2*t, t being the thickness of the WC wall. In practice, for mechanical reasons, it is difficult to obtain values thinner than 0.8 mm. The internal diameter of the external conductor is chosen in such a way that the coaxial waveguide operates under monomodal propagation, or, when the electric field is too strong, such a diameter can be increased up to a limit where the TM01 mode is below cut-off. In such a case the X-band transition must have the same symmetry of the Ka-band transition in such a way that modes TE11 V and H are not excited, thus guaranteeing the independence of the response with respect to the rotation.

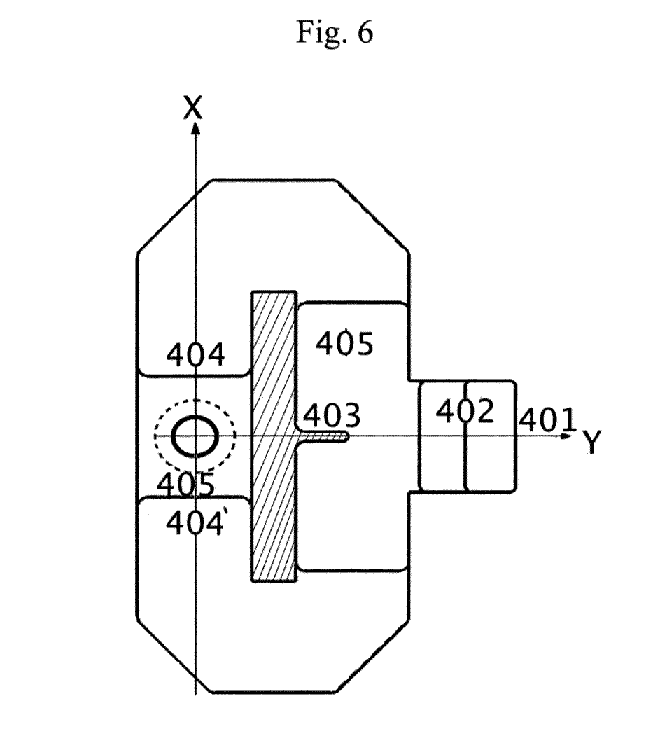

The transition between coaxial and rectangular waveguide on band A appears as shown in FIG. 6.

The signal incoming in port (401) is split into two identical parts through the bifurcation in the H plane. The steps (402) and the septum (403) are used for matching. There is a further matching step (404), used to compensate the mismatch generated by the transition between coaxial waveguide rectangular waveguide (405).

The main advantages of the proposed solution with respect to the more traditional ones, are:
1) High isolation between channels, due to the physical separation between the two cylindrical waveguides.
2) Higher peak power handling capability with respect to coaxial solution, because the nested section has not to be reduced to operate at higher frequency.
3) The two chokes are designed and operate independently from each other, thus guaranteeing an accurate control of the isolation.
4) The WOW is intrinsically negligible, because in the cylindrical part only azimuthal independent modes are excited.
5) Easy manufacturing.

Materials and dimensions of the above-described invention, illustrated in the accompanying drawings and later claimed, may be varied according to requirements. Moreover, all the details may be replaced by other technically equivalent ones without, for this reason, straying from the protective scope of the present invention patent application.

1. A power dual-band rotary joint simultaneously operating on two frequency bands, comprising, at least the following components:
a first transducer T1 connecting two rectangular waveguides WRA1 and WRB1 operating, on the bands A and B, respectively, the midband frequency of A being lower than the midband frequency of B, to a nested coaxial waveguide WN1 made up of two concentric pipes, having internal radii RA, and RB and whose internal wall thickness being TB;
a second transducer T2 connecting two rectangular waveguides WRA2 and WRB2 operating on bands A and B, respectively (the midband frequency of A being lower than the midband frequency of B; to a nested coaxial waveguide WN2 made up of two concentric pipes, having internal radii RA and RB and whose internal wall thickness being TB;
said two transducers and being connected through the two nested waveguides WN1 and WN2, in such a way that the aforementioned internal pipes are separated by a small gap while the two external pipes are connected through a bearing, making this arrangement possible the rotation of a transducer with respect to the other one, without affecting the electrical characteristics of the rotary joint;
the waveguides forming the transducer T1 being arranged in the order WRB1-WRA1-WN1, in such a way that the more internal pipe, TUB1, defining the waveguide WCB1, passes though WRA1, without any interruption or discontinuities;
the waveguides forming the transducer T2 (12) being arranged in the order WRB2-WRA2-WN2, in such a way that the internal pipe defining the waveguide WCB2, passes though WRA2, without any interruption or discontinuities;
a first choke, permitting the restoring of the electromagnetic continuity on band A in the coaxial waveguide bounded by the external surface of the internal pipe and the internal surface of the external pipe, forming the nested waveguide, and;
a second choke, permitting the restoring of the electromagnetic continuity on band B in the circular waveguide bounded by the internal surface of the internal pipe and able to provide a large isolation between the parts working on hand A and B.

2. The power dual-band rotary joint simultaneously operating on two frequency bands, as defined in claim 1, wherein:
said transducer T1 (11), providing the coupling between waveguides WRA1 and CXA1, on the one hand, and WRB1 and WCB1, on the other, has a symmetry which makes possible the excitation of the TM01 mode in WCB1, on band B, while lower order modes TE11V and TE11H, though above cut-off, are not excited at all;
the symmetry of said transducer T1, makes possible the excitation of only TEM mode in the waveguide CXA1, on band A, although other higher order not symmetrical modes can be above cut-off, on band A;
one end of the internal pipe of said nested waveguide WN1 is welded to the broad wall of WRB1 in such a way that the portion of the wall of WRB1 bounded by the intersection with the internal pipe of WN1 is removed in order to create a circular aperture through which energy flows from WRB1 to WCB1 (25), on band B;
one end of the external pipe of said nested waveguide WN1 is welded to the broad wall of WRA1 in such a way that the portion of the wall of WRA1 in between the two concentric pipes of WN1 is removed to create an annular aperture through which energy flows from WRA1 to CXA1 (26), on band A;
said transducer T2, providing the coupling between waveguides WRA2 and CXA2, on the one hand, and WRB2 and WCB2, on the other, has a symmetry which makes possible the excitation of the TM01 mode in WCB2 on band B, while lower order modes TE11V and TE11H, though above cut-off, are not excited at all;
the symmetry of said transducer T2 providing the coupling between waveguides WRA2 and CXA2, on the one hand, and WRB2 and WCB2, on the other, makes possible the excitation of only TEM mode in the waveguide CXA2, on band A, although other higher order non symmetrical modes can be above cut-off, on band A;
one end of the internal pipe of said nested waveguide WN2 is welded to the broad wall of WRB2 in such a way that the portion of the wall of WRB2 bounded by the intersection with the internal pipe of WN2, is removed in order to create a circular aperture through which energy flows from WRB2 to WCB2, on band B;
one end of the external pipe of said nested waveguide WN2 is welded to the broad wall of WRA2, while the internal pipe passes through WRA2 undisturbed, in such a way that the portion of the wall of WRA2 in between the two concentric pipes of WN2 is removed to create an annular aperture through which energy flows from WRA2 to CXA2, on band A;
just below WRA2, in the space between the broad wall of WRA2 and WRB2, the internal pipe is cut into two parts, TUB2_INF and TUB2_SUP, separated by a gap, in such a way that the lateral surface of the lower part, TUB2_INF, intersects the broad wall of WRB2, thus making the aperture through which energy flows from WRB2 to WCB2, while the higher part, TUB2_SUP is actually the continuation of the pipe TUB1, extending, without any discontinuity, from the broad wall of WRB1, passing through WRA2. to the break separating from the end of TUB2_INF,
electromagnetic continuity at the break of the internal pipe is restored through a choke, built by thickening the two juxtaposed collars which the two pipes TUB2_INF and TUB2_SUP end on, the aforementioned choke also producing the high isolation required between signals on A and B bands, necessary to prevent the leakage of the signal on band B to the waveguides operating on hand A.
